(19) United States
(12) Patent Application Publication
(10) Pub. No.: US 2010/0229404 A1
(43) Pub. Date: Sep. 16, 2010

(54) ASSEMBLED FOOTPLATE FOR HAND-HELD MACHINE TOOLS

(76) Inventors: Joachim Schadow, Leinfelden-Echterdingen (DE); Paul Stooss, Flumenthal (CH); Simon Haas, Guensberg (CH)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/738,450

(22) PCT Filed: Sep. 2, 2008
(86) PCT No.: PCT/EP2008/061564

§ 371 Date: Jun. 2, 2010

(30) Foreign Application Priority Data
Oct. 17, 2007 (DE) 10 2007 049 708.5

(51) Int. Cl. B23D 51/02

(52) U.S. Cl. 30/374

(57) ABSTRACT

An assembled footplate for hand-held machine tools, in particular power hacksaws, has a bottom sliding plate and a cover part, which together form a housing enclosure for a connecting element.

The invention relates to an assembled footplate for hand-held power tools, in particular jigsaws, as recited in the preamble to claim 1.

### PRIOR ART

Assembled footplates for hand-held power tools in the form of jigsaws are known from actual use and are embodied as steel footplates, which are composed of an upper part and lower part welded to each other, or as diecast aluminum footplates with a sliding plate composed of steel or plastic. Both parts perform the function of supporting the machine structure connected to the footplate and if only in connection with this function, are subject to certain limitations with regard to their structural design as well as the materials used in their manufacture.

### DISCLOSURE OF THE INVENTION

The object underlying the invention is to embody an assembled footplate or at least parts of a footplate so that with a light-weight construction, an improved functionality is achieved and in particular, an improved stability, improved sliding properties, and/or additional functionalities can be achieved.

According to the invention, this object is attained by means of the defining characteristics of claim 1 for assembled footplates according to the preamble to claim 1 and is also attained for footplates in general by means of the defining characteristics of claims 11 and/or 13.

An embodiment of an assembled footplate according to claim 1 offers the possibility, by means of the enclosure oriented toward the housing, of achieving an optimization of the footplate from the standpoints of both support and stability, namely through the use of a connecting element, which with a light-weight construction, permits the integration of a wide array of additional functions such as the integration of a dust collection system, the integration of an electrical angle-measuring device, and/or the integration of a light for the working area.

Regardless of these functionalities, suitable embodiments of enclosures oriented toward the housing are possible in which impact-absorbing corners are formed by means of the insert element protruding through the enclosure and/or a dust collection system is integrated into the footplate without this influencing the construction of the sliding plate or the cover part.

In particular, by means of the protecting and supporting function achieved by means of the cover part, the sliding plate can also be embodied as particularly light-weight, possibly more or less in the form of a sliding plate with an integrated sliding layer; with a corresponding stability of the sliding layer, if it is composed of a composite material, for example, then the sliding layer can also constitute the sliding plate, and in particular, a corresponding protection can be achieved at the edge by means of the covering structure. Particularly due to the protective function achieved by means of the impact-absorbing corners and the cover part, it is also possible to use materials for the sliding plate that are intrinsically fragile, e.g. sliding plates of die-cast aluminum, but whose fragility in combination with the protected arrangement has no negative repercussions on the performance characteristics of the power tool.

This concept can be expanded to include other cast-in inserts that can be useful not only with footplates or sliding plates composed of die-cast aluminum, but also with footplates or sliding plates that are manufactured out of composite materials or have a sliding layer made of composite material.

Other details, advantages, and suitable embodiments ensue from the remaining claims, the drawings, and the following description of the drawings.

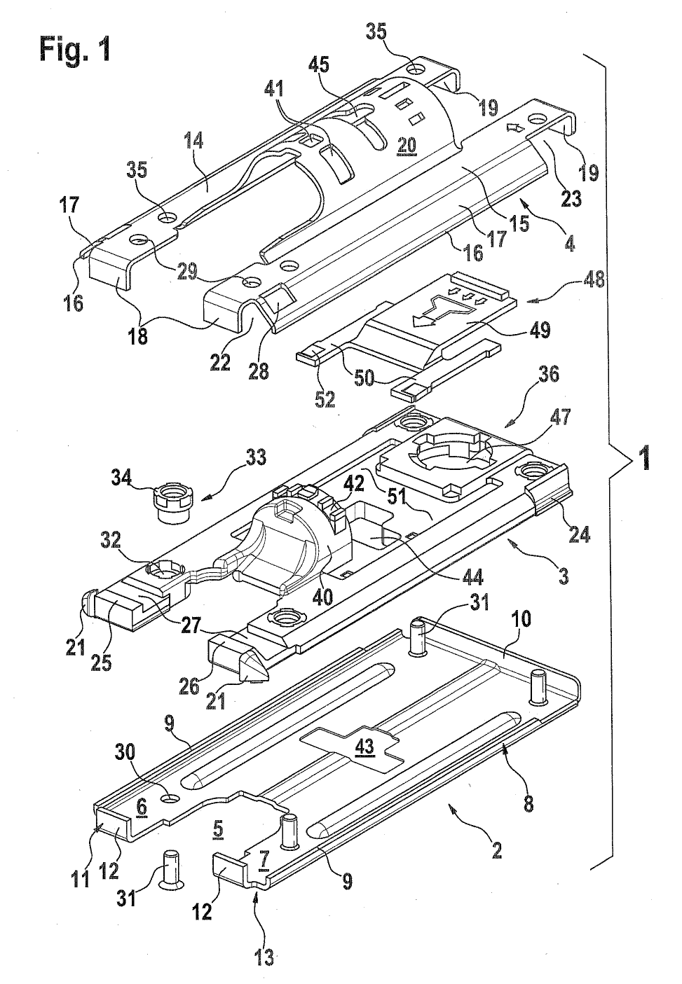

FIG. 1 is a schematic, perspective, exploded view of an assembled footplate for hand-held power tools; the footplate is essentially composed of a sliding plate at the bottom and a connecting element situated at the transition to a covering part and in a known fashion, the footplate constitutes the support for the drive part for the respective tool and the manipulating part of the hand-held power tool, which is in particular embodied as a jigsaw,

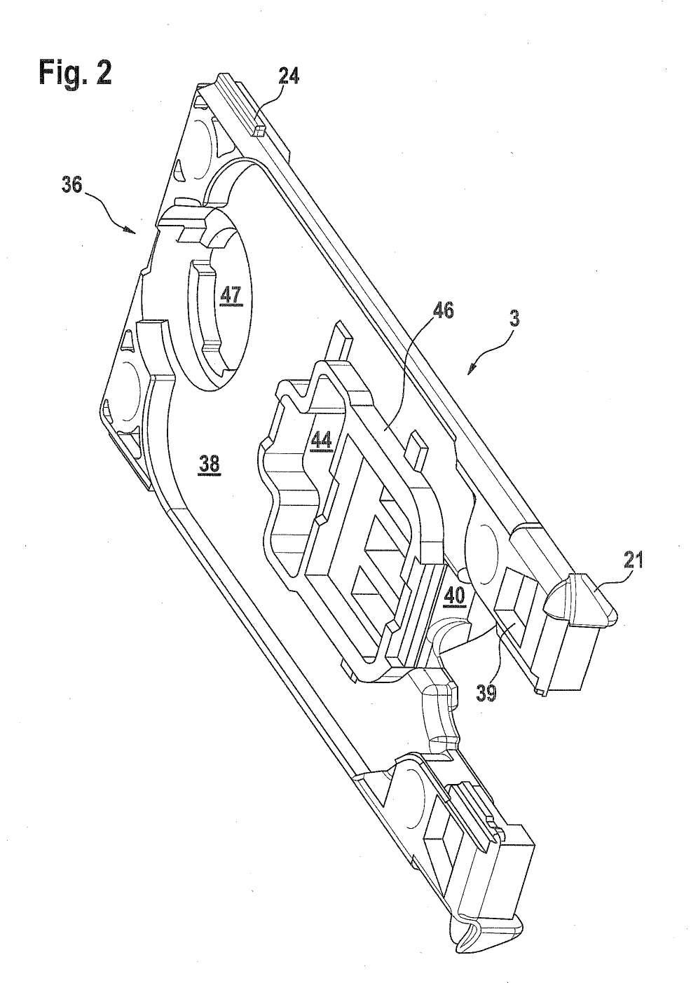

FIG. 2 is a perspective bottom view of the connecting element,

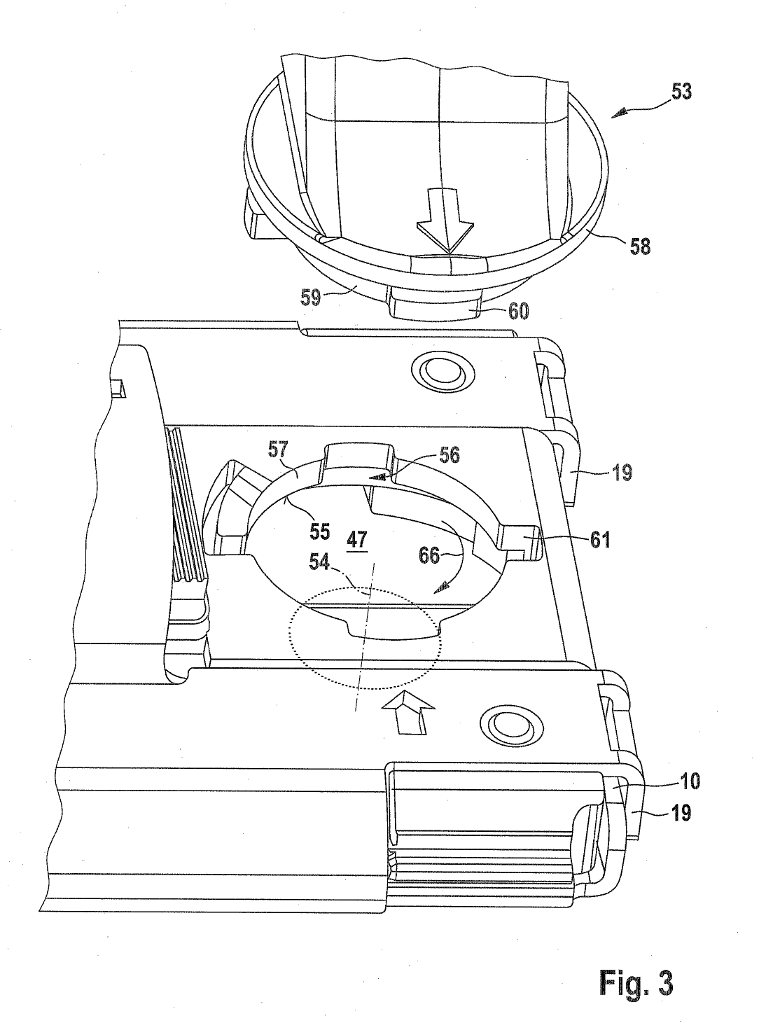

FIG. 3 is a perspective top view of the connecting region, situated at the end opposite from the tool end, for a dust collection system, showing its socket and the corresponding matching part of the suction line that can be inserted into the socket,

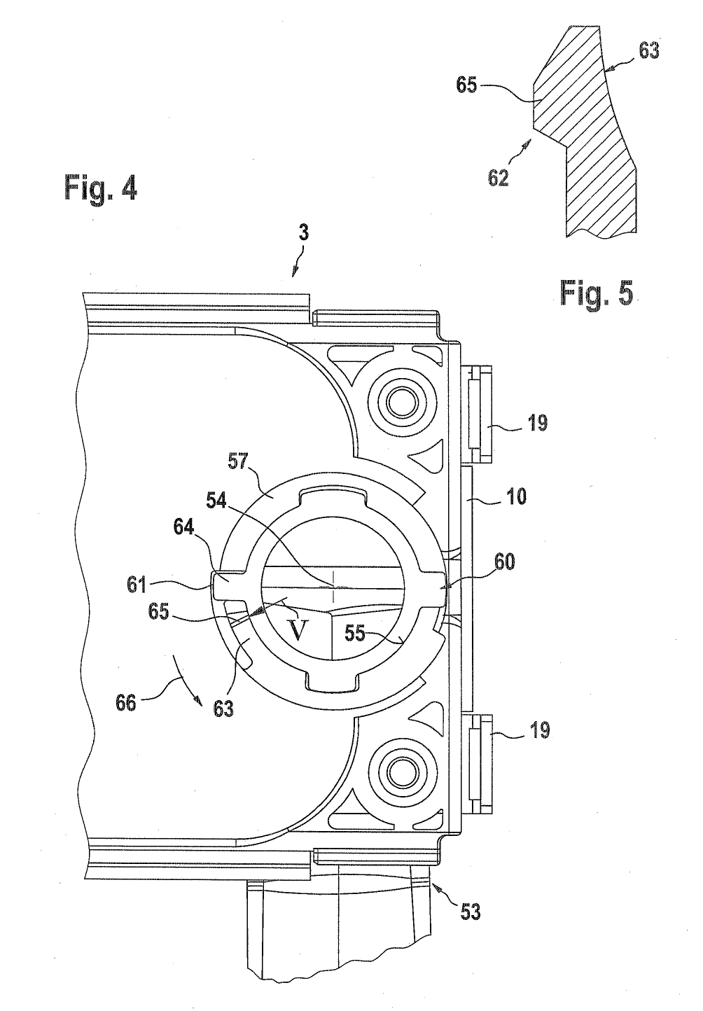

FIG. 4 is a bottom view of the end region of the footplate containing the socket; the suction line, with its matching part engaged in the socket is shown in a position that corresponds to the position of the matching part while the matching part is being inserted into the socket or while the matching part is being removed from the socket,

FIG. 5 is a depiction of the detail V in FIG. 4, in a view, from the radial inside, of the socket surrounding the inserted matching part,

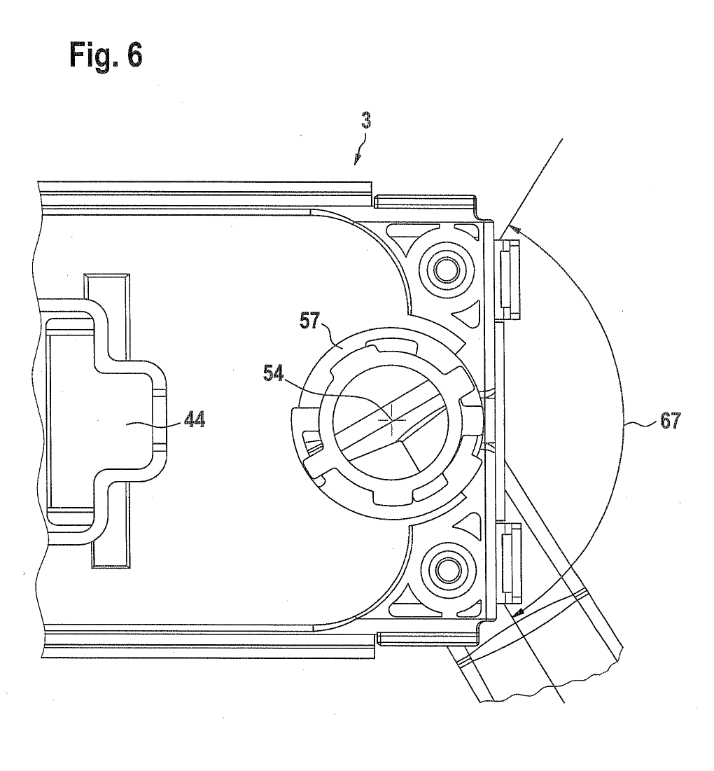

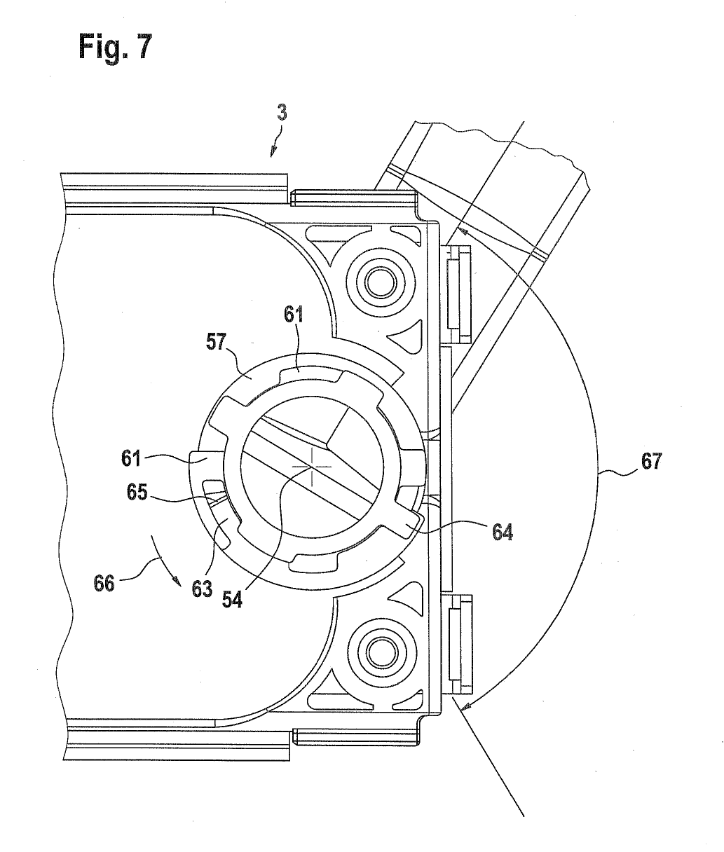

FIGS. 6 and 7 are depictions corresponding to FIG. 4 of the connection between the matching part and the socket; different pivoting positions of the suction line in relation to the footplate are shown, with corresponding rotational positions of the matching piece in relation to the socket when the matching piece is axially fixed in the socket,

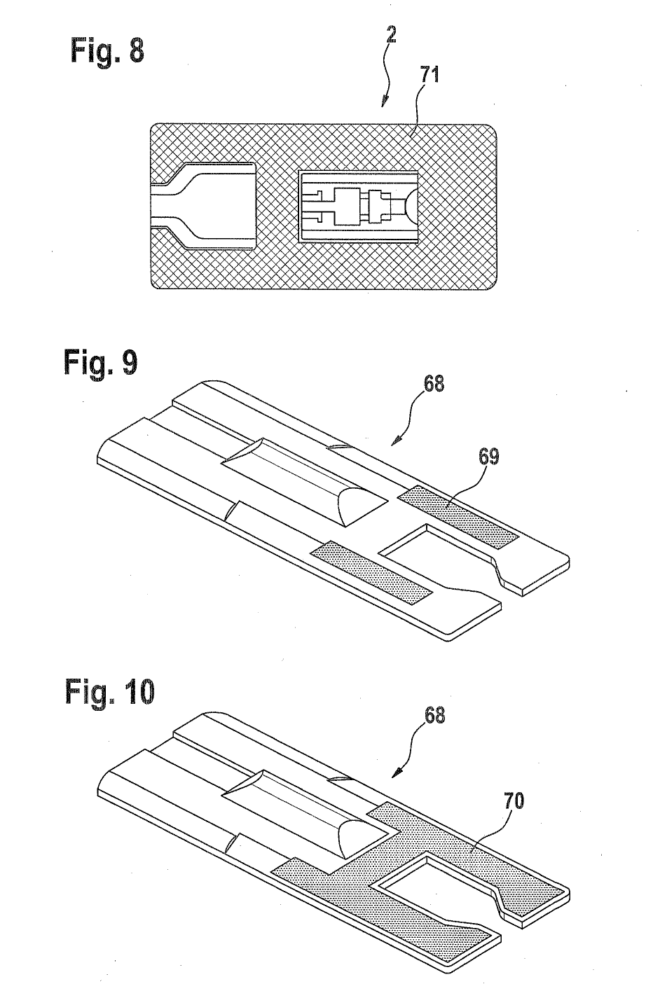

FIG. 8 is a bottom view of a hand-guided power tool, in particular a jigsaw, in which a sliding layer for the footplate is shown,

FIGS. 9 and 10 show embodiments of footplates for hand-guided power tools, in particular jigsaws, embodied in the form of cast components made of light metal, with cast-in, in particular metallic, supporting elements.

FIG. 1 shows the construction of an assembled footplate 1 for hand-guided, motor-driven power tools, in particular jigsaws, having a sliding plate 2 at the bottom, a connecting element 3, and a covering part 4. The sliding plate 2 and covering part 4 in the exemplary embodiment are embodied in the form of stamped and bent parts made of sheet metal that, in the assembled state of the footplate 1, enclose regions of the connecting element 3 in a housing-like fashion. The footplate 3 forms the base of the power tool, which is placed with the bottom surface of the sliding plate 2 onto a respective work piece. In addition, the footplate 1 constitutes the support for the rest of the machine structure, in particular of the machine housing, which contains the drive unit and guidance mechanism for the respective working tool, and of the machine handle belonging to the machine housing. As a rule, the machine structure is able to pivot in relation to the footplate 1 around an axis extending in the longitudinal direction of the footplate 1 so that it is possible to set working planes that are oriented at an angle to the footplate 1.

The sliding plate 2 of the footplate 1, embodied as a sheet metal plate in the exemplary embodiment, has a recess 5 at the front end, which is open toward the front and is delimited laterally by legs 6, 7 of the sliding plate 2; in the region of this recess, the working tool protruding from the machine structure passes downward through the sliding plate 2 and in the region below the sliding plate 2, engages the respective work piece onto which the sliding plate 2 is placed.

The sliding plate 2 has stabilizing corrugations extending in the longitudinal direction and over large regions of its circumference, is provided with a bent edge 8 including longitudinal side edges 9 and end edges 10 and 11 of which the end edge 10 extends across the width at the back of the sliding plate 2. The front end edge 11 is formed by bent tabs 12 situated at the ends of the legs 6 and 7 and these tabs end spaced apart from the transition to the longitudinal side edges 9, thus forming open corner regions. At the rear end, the longitudinal side edges 9 end spaced apart from the end edge 10.

In an embodiment corresponding to this embodiment of the sliding plate 2, the cover part 4 has longitudinal side strips 14, 15 that cover the legs 6, 7 and extend over the length of the sliding plate 2 and each transition at their outer lateral edge into longitudinal side bent edges 16 that correspond in length to the longitudinal side edges 9 and when the footplate is assembled, laterally embrace the outsides of the longitudinal side edges 9. Between the edges 16 and the strips 14, 15, there is a transition region 17 extending from the strips 14, 15 diagonally downward to the respective edge 16. At the front and rear ends, the strips 14, 15 terminate at tabs 18, 19 bent downward, with the tabs 18 overlapping the tabs 12 that are bent upward and provided at the ends of the legs 6, 7, while the rear tabs 19 overlap the end edge 10 that is bent upward at the rear.

The strips 14, 15 of the cover part 4 are connected to each other in the longitudinal center region by means of a connecting arch 20 that is curved upward and constitutes the support zone for the machine structure, not shown, situated above it.

When the footplate 1 is assembled, the sliding plate 2 and the cover part 4 sandwich the connecting element 3, which when set in place onto the sliding plate 2, has an outer contour that follows the latter's edges 8 through 11 and the boundaries of the recess 5. Protruding out from the corners of this contour at the front end, i.e. at the working end, projections 21 are provided on the connecting element 3, which fill in the corner regions 13, 22 that correspond to one another and are open at the edges of the sliding plate 2 and the cover part 4 so that when the footplate 1 is assembled, these projections produce impact-absorbing corners that protect and shield the front end.

Because of the circumferential edge overlap of the sliding plate 2 and cover part 4 and the resulting reciprocal support that this produces, the footplate 1 according to the invention has a high stability, in particular, the edges are supported toward the inside by the connecting element 3, which for its part, in the particularly critical front corner regions 13 of the housing-like enclosure formed by the sliding plate 2 and the cover part 4, provides a protection for the housing-like enclosure by means of the corner projections 21 that function as impact-absorbing corners. This also avoids impact damage to surrounding components during operation. In particular, the corner projections 21 also permit a particularly suitable and structurally beneficial embodiment of the particularly critical corner regions of the enclosure oriented toward the housing.

It is also clear from the drawings, in particular FIGS. 1 through 3, that in the transition region between the longitudinal edges 9 and the rear end edge 10, there is an opening 23 at the edge in the region of which adjustable guide elements 24 are situated, which are associated with the connecting element 3 and can be moved into a grasping position in relation to a worktable that is not shown. In this grasping position, the footplate 1 is locked in relation to the worktable so that the power tool, fixed in position by means of its footplate 1, can be used in stationary fashion despite being embodied in the form of a hand-held power tool.

In order to be able to use the machine in combination with a parallel, fence, in the region of its frontal side ends 25, 26, which overlap the legs 6 and 7 and in which the corner projections 21 are also provided, the connecting element 3 has channel-shaped recesses 27 extending transversely on its top, over which, when the footplate is assembled, are situated cutouts 28 provided in the transition regions 17 so that a parallel fence, by means of a guide arm extending through the cutouts 28 and guided in the recesses 27, can be fixed in relation to the footplate 1, which has insertion openings 29 for clamping screws or the like for this purpose in the region of the strips 15 of the cover part 4.

The clamping-together of the sliding plate 2 and cover part 4, with the connecting element 3 sandwiched between them to form the assembled footplate 1, can also be seen in FIG. 1; it is accomplished by means of screws 31, which are inserted into the sliding plate 2 from underneath, i.e. from the bottom side, in bores 30 and which pass through the connecting element 3 in openings 32, which accommodate spacer sleeves 33 that have an upper edge 34 embodied in a non-round form and with this edge, engage in a recessed edge region of the openings 32, particularly in a form-locked fashion. By means of the spacer sleeves 33, the cover part 4 is supported in relation to the sliding plate 2; in the context of a preferred embodiment, the cover part 4 is provided with holes 35 in the region of its slats and the screws 31 engage in these holes.

This type of connection of the sliding plate 2 and cover part 4 avoids stresses on the connecting element 3 occurring essentially due to the corresponding clamping so that as regards the material selection for them, the forces resulting from the clamping are immaterial and in particular, the connecting element 3 can also be embodied with regard to another function in addition to this, namely to make it possible in a simple way to collect dust from the working region, which is encompassed by the recess 5 and is associated with the front region of the footplate 1, and convey it to a dust collection connection 36 situated in the rear end region of the footplate 1. For this purpose, starting from its region corresponding to the recess 5 and laterally delimited by the side ends 25, 26, the connecting element 3 is embodied in the form of a cover of a dust collection conduit 38 that is delimited toward the bottom by the sliding plate 2; the dust collection conduit 38 is connected via suction openings 39 provided in the side ends 25, 26 to the region of the recess 5 that constitutes the working region. The conduit 38 is open to the dust collection connection 36, which is embodied in the form of a bayonet-like connection, as shown in greater detail in FIGS. 3 through 7.

Analogous to the connecting arch 20 of the cover part 4, the connecting element 3, axially adjacent to its region that is recessed in accordance with the recess 5 of the sliding plate 2, is provided with a dome-shaped arch 40, which in turn is provided with marking supports 42 situated in the region of cutouts 41 arranged one after another in the circumference direction in the connecting arch 20, which marking supports 42 coincide with the cutouts 41 so that with regard to a on the (sic) machine structure, which is able to pivot in relation to the footplate 1 around the latter's longitudinal axis, and a marking transmitter provided on it, it is possible to read the respective pivoted position, which can be fixed by means of a preferably detent-engaging connection between the machine structure and the connecting arch 20.

In its longitudinally central region, the sliding plate 2 is provided with a cutout 43 which, with regard to the assembled footplate 1, is situated to coincide with an opening 44 in the connecting element 3, which is offset toward the rear in relation to the arch 40. Coinciding with the opening 44, the connecting arch 20 in turn has a guide slot 45 for a clamping bolt, not shown, that serves to clamp the machine structure, not shown, to the footplate 1 so that it is able to pivot around the longitudinal axis extending in the longitudinal direction of the footplate 1; the fixing of the clamping bolt to a corresponding pivoting support resting against the connecting arch 20 occurs by means of a clamping screw that can be accessed from the bottom of the sliding plate 2 via the cutout 43.

As shown in FIG. 2, the region around the dome-like arch 40 and the opening 44 is delimited in relation to the dust collection conduit 38 by an enclosure 46 that simultaneously comprises a support for the sliding plate 2 when the footplate 1 is assembled, thus permitting the sliding plate 2 to be embodied with correspondingly thin walls.

FIG. 1 also shows that the suction opening 47 of the suction connection 36 situated at the socket end in the connecting element 3 is suitably associated with a cover that is embodied in the form of a pivoting or sliding cover 49. The drawing shows an embodiment of it in the form of a sliding cover 49 that is guided so that it is able to slide in the longitudinal direction of the footplate 1 in relation to the connecting element 3; to guide and hold the sliding cover 49, runners 50 are provided, which are situated to the side of the sliding cover and engage in guide recesses 51 in the connecting element 3. The guide recesses 51 largely coincide with the longitudinal side strips 14, 15 of the cover part 4 so that holding and guiding the sliding cover 49 involves no particular difficulty and in particular, its open and closed position can also be assured in a particularly simple way by means of detent engagement, as indicated by the reference numeral 52. A support for a pivoting cover can also be achieved in a comparably simple fashion if it is provided with lateral supporting pins that are secured in supporting recesses of the connecting element 3, situated in the region in which it coincides with the strips 14, 15 of the cover part 4.

FIG. 3 shows the position, with the sliding cover 49 open, of a suction fitting 53 associated with the suction opening 47 and embodied in the form of a matching part, in a position in which the suction fitting 53 is aligned with the suction opening 47 in such a way that the suction fitting 53 can be inserted into the suction opening 47. In a corresponding fashion, the suction fitting 53 can also be withdrawn from the suction opening 47 in the opposite direction.

The thus-defined assembly position of the suction fitting 53 in relation to the suction opening 47 represents a starting position from which after moving past a stop 62 (FIG. 5), the suction fitting 53, by being rotated around the axis 54, can be moved into a working pivoting range 67 that has stop-delimited end positions, as shown in FIGS. 6 and 7.

The assembly position according to FIG. 5, in which the suction fitting 53 is to be inserted into the suction opening 47 or removed from it, lies outside the stop-delimited pivoting range 67; in the direction toward the assembly position, it is necessary to override the stop 62, which is correspondingly embodied as an overridable stop.

The drawings show that the connection between the suction opening 47 and the suction fitting 53 is embodied in the form of a bayonet coupling. To this end, the suction opening 47, at its end oriented toward the suction fitting 53 to be inserted, is provided with a reentrant rim 57 whose inner circumference 55 centered on the axis 54 of the suction opening 47 constitutes the radial guide for the inserted suction fitting 53. The rim 57, which has different radial widths in its inner circumference 55 centered on the axis 54 and may also have corresponding regions with different axial heights, is provided with radial notches 56 that open toward the axis 54.

The support collar 58 of the suction fitting 53 protrudes radially beyond a ring region 59 of the suction fitting 53 that adjoins it in the insertion direction, i.e. axially, with which the suction fitting 53 rests radially against the rim 57 radially beyond (sic). In the ring region 59 spaced axially apart from the support collar 58, radial projections 60 are provided, which viewed from above, are each embodied to correspond to a respective notch 56 in the circumference contour so that the assembly position is predetermined as an insertion position of the fitting 53 into the suction opening 57.

From this insertion position, the end of the fitting 53 inserted into the suction opening 47 is only able to rotate in one rotation direction—corresponding to that of the arrow 66—toward the working pivot range 67. In the opposite direction, there is a non-overridable limiting stop. This is achieved by the fact that the projection 64 corresponding to the notch 61 in the assembly position, in its movement path that engages beneath the rim 57, is associated with a stop that protrudes into the movement path radially from the circumference of the suction opening 47 or from the underside of the rim 57.

In the opposite direction, i.e. in the direction of the arrow 66, the stop fitting 53 is able to rotate around the axis 54; the transition from the assembly position according to FIGS. 3 and 4 to the nearer end position of the working pivoting range 67 is secured by means of an overridable stop 62 (FIG. 5).

This overridable stop 62 is composed of a radially cut-out region of the rim 57 that extends in the direction opposite from the arrow 66 toward the notch 61, is embodied to be resiliently flexible in the axial direction in the fashion of a tab 63, and protrudes into the movement path of the projection 64, which path lies beneath the rim 57. The pivoting motion of the fitting 53 from its position according to FIG. 5, which corresponds to the assembly position, into the working pivoting range 67, whose end positions are shown in FIGS. 6 and 7, requires the projection 64 that coincides with the notch 61 in the assembly position to force the tab 63 downward out of the movement path, during the overriding movement. To this end, the tab 63 is associated with a knuckle 65 and depending on the embodiment of the knuckle 65, as shown in FIG. 5, produces a stop position that is overridable both in the direction toward the assembly position and in the opposite direction.

Appropriate dimensioning of the radial projections 60 in their radial length and also in their width measured in the circumference direction, together with the corresponding dimensioning of the notches 56, assures that an insertion of the suction fitting 53 into the suction opening 47—and also a corresponding removal of the suction fitting 53 from the suction opening 47—is only possible in the assembly position according to FIGS. 3 and 4. Beveling the top of the tab 63 toward its free end so that a receding shoulder for the support surface of the rim 57 is produced for the support collar 58 facilitates the insertion of the suction fitting 53 into its assembly position according to FIG. 4.

Furthermore, the dimensioning of the projections 60 and notches 56 also assures that in the intermediate positions of the working pivot range 67, despite the fact that the projections 60 travel past the notches 56, they are prevented from traveling into them. FIGS. 4 through 7 in particular show how these notches 56 and projections 60, with their different dimensions in both the circumference direction and the radial direction, match one another in the assembly position, but outside of the assembly position, prevent a reciprocal engagement between the projections 60 and notches 56.

The projection 64 associated with the notch 61 in the assembly position, in a stop-delimited fashion, determines both the assembly position and the limit of the working pivot range 67. The maximum pivoting distance of the suction fitting 53 in the direction toward the end position remote from the assembly position is delimited by the fact that the radial projection 64, which is associated with the notch 61 in the assembly position, travels through a circumference region of the suction opening 47 that is delimited by a stop. This stop can, as shown, be embodied by providing a radial outward expansion of the suction opening 47 in the travel range of the projection 64, thus producing a stepped shoulder serving as a stop in the direction toward regions adjoining the movement path in the circumference direction. In a particularly simple way, this approach can also be used to establish the opposite end positions of the assembly position and the working pivot range.

The embodiment according to the invention, with a connecting element 3 that is enclosed in housing-like fashion and is correspondingly also protected and stabilized, advantageously also offers the possibility of using the connecting element 3 for the integration of additional functions, for example a lighting, not shown, of the working region situated in the vicinity of the recess 5 of the sliding plate 2 and/or the integration of an electrical measuring device for determining the angular position of the handle-equipped machine structure, not shown, that is able to pivot around the longitudinal axis of the footplate 1. A measuring device of this kind can, in particular, be provided in the region of the dome-like arch; in addition, it also turns out to be suitable to indicate the angle by means of a display that is provided in the region of one of the edges 15, 16 of the cover part and is therefore easily visible. A battery compartment can also be suitably accommodated in the region of the arch 40, preferably covered by the latter. For the lighting, it turns out to be particularly useful to provide corresponding light sources in the connecting element, to the sides of the recess 5; a respective light source can also be associated with each of the side ends 25, 26 and by means of the light sources situated in a protected fashion at the side ends 25, 26, it is possible to achieve an overlapping, in particular intersecting, lighting of the region in which the respective tool accesses the associated work piece.

The scope of the invention includes embodying the bottom surface of the sliding plate 2 in a friction-optimized fashion in order to facilitate work and to improve the work quality, which is shown in the exemplary embodiment according to FIG. 8 in that the bottom of the sliding plate 2 is provided with a corresponding layer 71, for example composed of carbon fiber or a synthetic resin-bonded glass fiber composite material. Such glass fiber composite materials are referred to as phenoplasts, for example.

Particularly in connection with an embodiment of the footplate with the design according to FIG. 1, the scope of the invention also includes manufacturing the sliding plate 2 entirely of such a material, particularly since in an embodiment according to the invention shown in FIG. 1, which has an overlapping cover part 4, the sliding plate is also correspondingly protected at the edge by the cover part 4. A corresponding protection at the edge, overlapping the connection plane between the sliding plate 2 and the sliding layer 71, can also be achieved by situating the sliding layer 71 inside an edge bead of the sliding plate 2 beyond which the sliding layer 71 protrudes so that the sliding surface of the sliding layer 71 is offset in relation to the edge bead.

Such a friction-optimized embodiment of the sliding plate 2 is generally also advantageous in other motor-driven hand-held tools, particularly also from the standpoint of a corresponding weight reduction with improved maneuverability.

FIGS. 9 and 10 show other embodiments of footplates, in particular for footplates 68 of hand-guided, motor-driven circular saws and jigsaws that are, for example, also manufactured using the diecasting process. With regard to such footplates 68, or correspondingly embodied sliding plates in assembled footplates, particularly in terms of improving their stability and especially their impact-resistance and fracture-resistance, it turns out to be advantageous to provide them with corresponding reinforcing inserts 69 or 70 particularly in vulnerable regions; these inserts, as indicated by reference numeral 69, can be embodied in the form of inserted solid elements, such as tubes or pins, or as indicated by reference numeral 70, can be embodied in the form of sheet metal parts, e.g. stamped and bent parts, which are cast-in, i.e. incorporated into the element during manufacture, and thus require no additional subsequent work steps for reinforcing or protecting the footplate or a sliding plate belonging to the footplate. In particular, footplates 68 of this kind, but also sliding plates, can also be coated in a friction-optimized fashion, as has been explained by way of example in connection with FIG. 8. Suitable inserts particularly include metallic inserts that have a higher modulus of elasticity than the respective base material of the molded footplate, i.e. a higher modulus of elasticity than aluminum or the alloy used.

1-13. (canceled)

14. An assembled footplate for hand-held power tools, in particular jigsaws, having a sliding plate at the bottom, a machine structure, and a connecting element situated at the transition from the sliding plate to the machine structure, characterized in that the connecting element is embodied in the form of an insert for a footplate enclosure that is oriented toward the housing and is constituted by the sliding plate and a cover part.

13. The assembled footplate as recited in claim 14, wherein the cover part overlapping the connecting element is attached to the sliding plate.

16. The assembled footplate as recited in claim 14, wherein the cover part is situated so that its edge overlaps the sliding plate.

17. The assembled footplate as recited in claim 15, wherein the cover part is situated so that its edge overlaps the sliding plate.

18. The assembled footplate as recited in claim 14, wherein the sliding plate and the cover part are embodied in the form of stamped sheet metal parts.

19. The assembled footplate as recited in claim 17, wherein the sliding plate and the cover part are embodied in the form of stamped sheet metal parts.

20. The assembled footplate as recited in claim 14, wherein the connecting element is comprised of a plastic component.

21. The assembled footplate as recited in claim 19, wherein the connecting element is comprised of a plastic component.

22. The assembled footplate as recited in claim 14, wherein the connecting element delimits a suction conduit against the sliding plate, which conduit ends at a suction connection.

23. The assembled footplate as recited in claim 21, wherein the connecting element delimits a suction conduit against the sliding plate, which conduit ends at a suction connection.

24. The assembled footplate as recited in claim 22, wherein the suction connection has a stop-delimited, pivotable connection to a suction fitting and this connection is releasable in bayonet-like fashion.

25. The assembled footplate as recited in claim 23, wherein the suction connection has a stop-delimited, pivotable connection to a suction fitting and this connection is releasable in bayonet-like fashion.

26. The assembled footplate as recited in claim 24, wherein the suction connection is closable by means of a lid-like cover.

27. The assembled footplate as recited in claim 25, wherein the suction connection is closable by means of a lid-like cover.

28. The assembled footplate as recited in claim 14, wherein the footplate has an integrated angle measuring device.

29. The assembled footplate as recited in claim 27, wherein the footplate has an integrated angle measuring device.

30. The assembled footplate as recited in claim 14, wherein the assembled footplate is provided with a lighting device for the working region of the tool.

31. A footplate, in particular an assembled footplate as recited in claim 14, for a hand-held power tool with a sliding plate on the side oriented toward the work piece, characterized in that the sliding plate is provided with a sliding layer.

32. The assembled footplate as recited in claim 31, wherein the sliding layer is made of a composite material.

33. A footplate, in particular an assembled footplate for hand-held power tools as recited in claim 14, characterized in that the footplate, which is embodied as a molded element, is provided with a cast-in reinforcing insert.
